(19) United States
(12) Patent Application Publication
(10) Pub. No.: US 2003/0229707 A1
(43) Pub. Date: Dec. 11, 2003

(54) Method and apparatus for rapid file transfer to embedded system

(75) Inventors: Amir Sharon, Ramar Hasharon (IL); Lior Avital, Kfar Saba (IL); David Feldman, Natania (IL)

Correspondence Address: Fogg Slifer Polglaze Leffert & Jay, P.A., P.O. Box 581009, Minneapolis, MN, 55458-1009, US

(73) Assignee: ADC Telecommunications Israel Ltd.

(21) Appl. No.: 10/164,733

(22) Filed: Jun. 6, 2002

(51) Int. Cl. G06F 15/16

(52) U.S. Cl. 709/230

(57) ABSTRACT

A method of transferring data from a host system to a target system includes creating a data record for transmitting data to the target in which the record includes a starting address for loading a sequence of data into a memory of the target system, one or more error detection codes, and an uninterrupted sequence of data for loading sequentially into the memory.

### TECHNICAL FIELD

The present invention is related in general to a method and apparatus for rapid and efficient exchange of programs and data between computer systems, and in particular to the rapid downloading of programs and data to embedded systems.

### BACKGROUND INFORMATION

Embedded systems are specialized computer systems or controllers dedicated to performing functions for specific systems or machines. Embedded systems are pervasive and may be found in devices ranging from children's toys, watches, microwave ovens, VCRs and automobiles, to guided missiles and complex robots. Typically an embedded system is housed on a single microprocessor board with the programs stored in nonvolatile memory. While some embedded systems include an operating system, many are so simple that the entire logic can be implemented in a single program.

Programs and data files are initially transferred to the target system by a host as part of the manufacturing process. Program upgrades may also be downloaded from time to time as new versions become available. Downloading a program upgrade involves transferring data (the term “data” as used herein includes program code) to an embedded system or target. Data is typically transferred to the embedded system by a cross assembler or cross compiler that generates program code and data in a format that is suitable for transport to the embedded system. Such files typically include ASCII encodings of hex instruction codes for transmission over a data link such as an RS-232 or the like. The files are converted to executable code by a boot application that resides on the target embedded system.

Transferring ASCII files to embedded systems is relatively slow and can add considerable time to the manufacturing process, particularly since the boot application on the target system is executed from the embedded system's boot ROM which is typically much slower than the memory of the PC or other computer system that provides the ASCII encodings. Thus, it would be highly advantageous to speed up and streamline the process of transferring programs and data to embedded systems.

### BRIEF DESCRIPTION OF THE DRAWINGS

FIG. 1 is an illustration of one example of a system according to the teachings of the present invention.

FIG. 2 is an illustration of one example of an S-record.

FIG. 3 is an example of the S-record of FIG. 2 that has been transformed into a streamlined format or data structure according to the teachings of the present invention.

FIG. 4 is a flow diagram showing an example of the operation of a system for transferring data to an embedded system according to the teachings of the present invention.

FIG. 5 is a flow diagram of an example of the operation of s process to convert or transform data in an S-record or HEX record format to a streamlined format or data structure according to the teachings of the present invention.

### SUMMARY

A method for rapid transfer to embedded system according to one aspect of the present invention includes providing data from a host system to a target in a file format or data structure that includes a starting address a sequence of data to be contiguously loaded into a memory of the target, and an error detection code such as a CRC. In another aspect, the present invention includes a data structure or a file format for transmission from a host computer to a target in which the data structure includes a data start address an error detection code and an uninterrupted sequence of data to load in consecutive addresses of the memory of the target beginning with the data start address.

### DETAILED DESCRIPTION

In the following detailed description of the preferred embodiments, reference is made to the accompanying drawings that form a part hereof, and in which are shown by way of illustration specific embodiments in which the invention may be practiced. It is to be understood that other embodiments may be utilized and structural changes may be made without departing from the scope of the present invention.

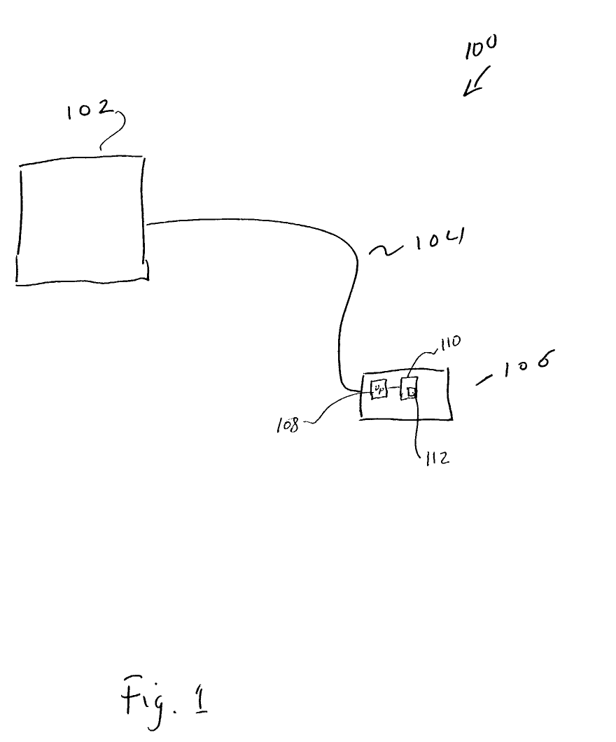

FIG. 1 shows a system 100 for transferring data from a host computer 102 over a communications link 104 to an embedded system or target 106. The target system 106 includes a processor 108, a memory 110 and a loader program 112 in the memory, sometimes referred to as a boot program, for handling operations related to loading, checking and parsing programs received over the communications link 104. Common formats for transport of programs and data to embedded systems in use are S-records and “Intel-Standard” HEX files. The Intel HEX file is one of the most popular and commonly used formats in the Intel microcontroller world. The Intel HEX file is used to burn the program into an EPROM, PROM, etc. of the target system. For example, an assembler running on a PC may be used to generate an Intel HEX file which can then be loaded into an EPROM programmer and burned into the chip.

Both the S-record and Intel HEX formats are ASCII (text) containing one record per line. They are designed to be easily created, edited and viewed with a simple text editor, and can be sent across phone lines or serial ports (RS-232) without binary protocols. For purposes of illustration, the S-record format will be discussed in detail, but it will be understood by those of ordinary skill in the art that embodiments of the invention of the present application apply equally to the Intel HEX file format and other text-based file formats for transport of programs and data to embedded target systems.

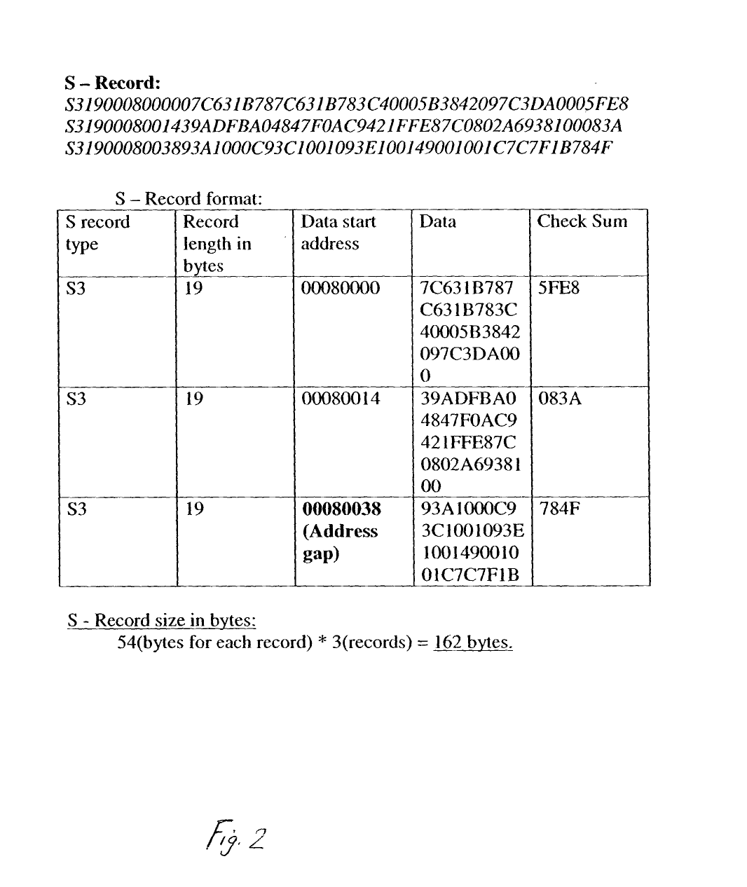

FIG. 2 shows an example of a 3 line S-Record file for transmission to an embedded system. Each line or record is individually loadable and can be cut out and added to other S-Record files. Each line is divided into five parts from left to right: Type, Record Length, Address, Code/Data, and Checksum.

The Type portion of an S-record line is two bytes long and identifies the type of record for the target system. For example, an S0 record holds a description of the file or a comment. The S0 record would thus be ignored by the target system and not loaded. Types S1, S2, and S3 records identify the line as containing program code or data to be loaded into the target system and that the address is 2, 3 or 4 bytes long, respectively. Type S5 contains the count of the S1, S2 and S3 records previously transmitted. Types S7, S8 and S9 contain the starting execution address which is 2, 3 or 4 bytes long, respectively, and tell the target system that the S-record send is completed.

The Record Length portion of an S-record line is two bytes long and identifies the number of bytes in the S-record line after the record length.

The Address portion of an S-record line tells the loading program of the target where to load the line into memory.

The Code/Data portion of an S-record line is the actual data or code to be “burned” or loaded into the target system represented as 2 digit hexadecimal values.

The Checksum portion of an S-record may be 2 or 4 bytes long. The checksum is the sum of all of the bytes in that line and provides a simple error check for this line. The target system recomputes the checksum based upon the received data and compares this value with the one sent with the data. If the two values are the same, the target has some confidence that the data was received correctly.

FIG. 2 shows an example of three S-record lines. All three lines are of type S3, indicating that the data in the records is 4 bytes long. The record length of each line is 19 bytes. The first S-record has a data start address of 00080000 which tells the target 106 that the data is to be loaded sequentially into memory 100 starting at memory address 00080000. The second S-record has a data start address of 00080014 which tells the target 106 to load the data from the second line at the memory address immediately following the data from the first S-record without any address gaps in between. The third S-record has a data start address of 00080038 indicating that there is to be an address gap between the data from the second S-record and the data from the third S-record. Each of the three S-records ends with a two-byte checksum.

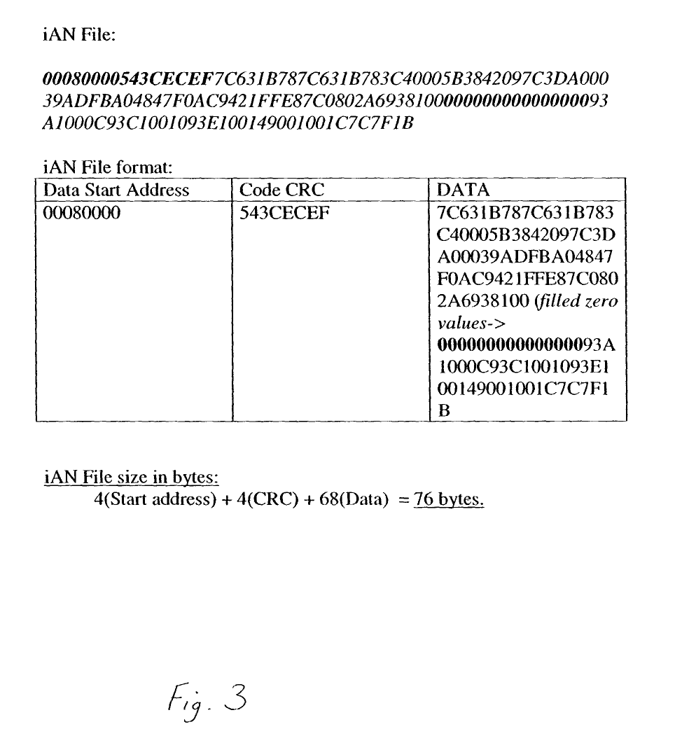

FIG. 3 shows an example of the present invention in which the S-record file of FIG. 2 has been converted to a streamlined format or data structure according to the present invention. Records created in or converted to a format or data structure according to the present invention may be referred to as “iAN files.”

The data structure or format of the present invention differs significantly from the S-record format. Instead of breaking up the data into several records or lines, each of which includes a Type identifier, Record Length, Address, Code/Data, and Checksum, a record or file format according to the present invention simply provides a data start address followed by an error check code, for example, a cyclic redundancy code (CRC), followed by a single uninterrupted sequence of data for contiguous loading into the memory of the target. In the event that the data is not meant for contiguous loading into the target memory, i.e., the data contains an address gap, a file format according to the present invention may include a sequence of zeros (or other place holding characters as may be appropriate for the memory) to fill in the address gap. Thus, advantageously, the target system needs only one address for the data to be downloaded and the addresses required for each line of data in an S-record type format, is eliminated.

The streamlining according to the present invention can eliminate a great deal of data overhead and save time. For example, the file containing the three line S-record of FIG. 2 includes 162 bytes. That same data, streamlined to the format of the present invention has been reduced to a file of 76 bytes. Even greater savings may be achieved when the present invention is applied to larger files.

In one embodiment of the present invention, a cyclic redundancy code (CRC) is used rather than a checksum to determine that the data has been received by the target correctly. While a checksum could be used it is prone to errors. For example, in the case of an 8-bit checksum, if a number of random corruptions occur, there is a 1 in 256 chance that they will not be detected. This is unacceptable in many applications. A CRC, on the other hand is much more reliable. A CRC, like a checksum, is a number derived from, and stored or transmitted with, a block of data in order to detect corruption. It is recalculated by the target system and compared to the value originally transmitted to detect transmission errors. A CRC however is calculated using polynomial division instead of simple addition. The basic idea of CRC algorithms is simply to treat the data as an enormous binary number, to divide it by another fixed binary number and to make the remainder from this division the checksum. Upon receipt of the data, the target can perform the same division and compare the remainder with the “checksum” (transmitted remainder).

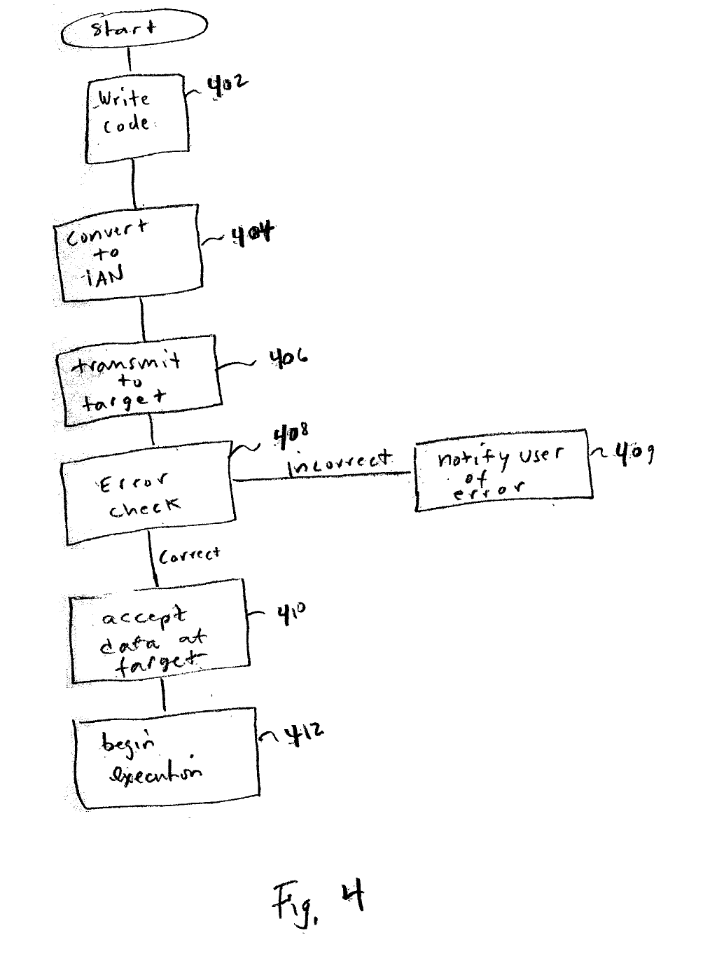

Operation of one example of the present invention will now be described. FIG. 4 shows a flow diagram of the process of transferring a file from a host system 102 to a target 106 according to the present invention. In 402 a user generates code to be transferred to the target 106. The code may be written in a format that is directly downloadable to the target (such as an S-record file or streamlined file format or data structure according to the present invention (“iAN”)). Alternatively, the file may be converted to the format of the present invention directly from a high level language such as C or from assembly code. In addition, S-record or Intel HEX files (or the like) may be converted or compressed into a streamlined file format or data structure according to the present invention.

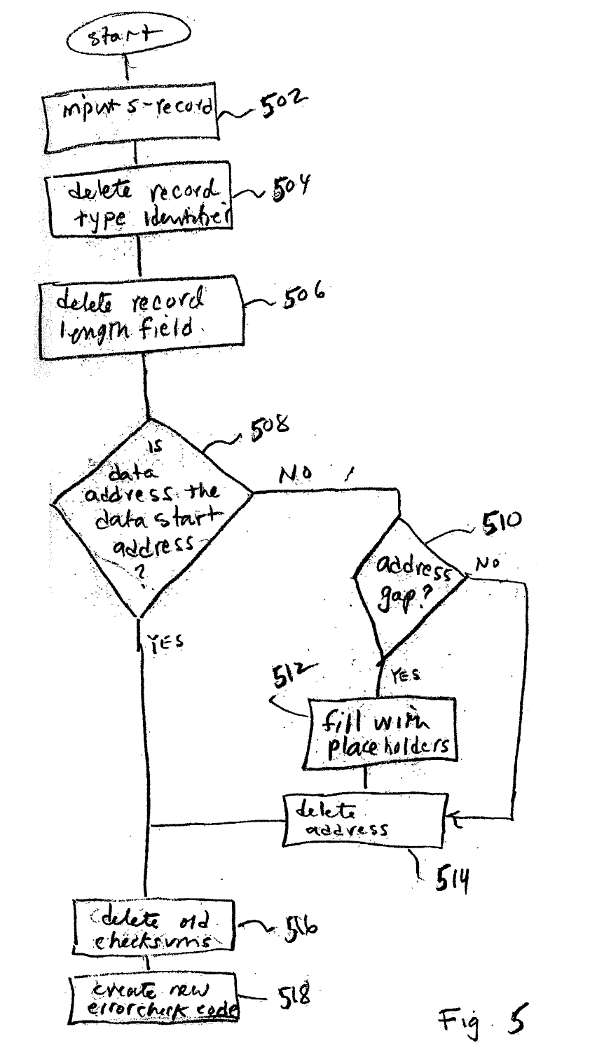

FIG. 5 shows a generalized example of a method or procedure for compressing a text based file that includes a plurality of S-records or HEX records to a file format or data structure according to the present invention. A procedure for converting S-record type files would generally include the following operations, though not necessarily in the following order. The S-records are input at 502, either one line at a time or as an entire file. At 504, each occurrence of a record type identifier is deleted. At 506 each occurrence of a record length field is deleted. Since only one data start address is needed for the entire file, it is determined at 508 whether a data address is the (first) data start address. If it is that data start address becomes the data start address for the iAN file. If not, it is determined at 510 whether there is an address gap. If there is an address gap, the gap is filled with place holding characters, such as zeros, at 512. The unnecessary data start address is then eliminated at 514. The line by line error check code is deleted at 516. After all S-record lines have been processed, a new error check code (such as a CRC) is created for the data of the entire file at 518 and the new compressed file is ready to be sent to target 106.

Once the file has been converted to the format of the present invention it may be transferred at 406 to the target system 110 over an interface or transmission link 104. After the file has been received the target 106 performs an error check 408 of the data with the CRC or other error check bits transmitted with the data file. If the error check fails, the user is notified that there is a problem at 409. Following a satisfactory error check, the data is accepted by the target system at 410. At 412 the target 106 may immediately jump to execution of the program in response, for example, to an end of file character at the end of the data that has just been loaded into memory 110 or the target 106 may perform one or more test procedures or programs, or await further instructions, as would be familiar to those of ordinary skill in the art.

Conclusion

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the present invention. Therefore, it is intended that this invention be limited only by the claims and the equivalents thereof.

What is claimed is:

1. A method of providing data from a host system to a target, comprising:
creating a file for transmitting to the target, the file comprising a starting address a sequence of data to be contiguously loaded into a memory of the target, and an error detection code.

2. The method of claim 1 wherein the error detection code comprises a cyclic redundancy code.

3. The method of claim 1 further comprising converting the data file from ASCII based records.

4. The method of claim 1 further comprising converting the data file from an S-Record format.

5. The method of claim 1 further comprising converting the data file from a HEX file format.

6. A data structure on a computer readable medium of a host computer for transmission from the host computer to a target, comprising:
a data start address;
an error detection code; and
an uninterrupted sequence of data to load in consecutive addresses of the memory of the target beginning with the data start address.

7. A data structure for transmission of data from a host to a target system, comprising the following physical organization:
a data start address;
an error detection code; and
an uninterrupted sequence of data to load in consecutive addresses of the memory of the target system beginning with the data start address.

8. The data structure of claim 7 wherein any address gaps in the data are filled in by place holding characters.

9. The data structure of claim 8 wherein the place holding characters are zeroes.

10. The data structure of claim 7 further comprising an end of file indicator.

11. The data structure of claim 8 wherein the end of file indicator comprises an execution start address.

12. A method of reducing the size of an ASCII based file comprising a plurality of lines of ASCII records for loading to a target system, the method comprising:
converting the lines of ASCII records into a file comprising a data start address, an error check code, and a stream of data for loading sequentially into the memory beginning at the data start address.

13. A file format for loading data from a host to a target, the file format comprising:
a data start address;
an error check code; and
a single uninterrupted sequence of data to be loaded into consecutive addresses of a memory of the target.

14. The file format of claim 13, wherein the data is configured for contiguous loading into a memory of a target system.

15. The file format of claim 14 wherein an address gap is filled in by a sequence of place holding characters in the single uninterrupted sequence of data.

16. The file format of claim 13, wherein the error check code is a cyclic redundancy code.

17. A method of compressing a text based file comprising a plurality of records, the method comprising:
deleting each occurrence of a record type identifier;
deleting each occurrence of a record length field;
deleting each occurrence of a data start address except the first occurrence thereof;
combining data from each record into a single uninterrupted sequence of data wherein any address gaps are filled with a sequence of place holding characters; and
creating an error check code for the combined data.

18. The method of claim 17 wherein the records comprise S-Records.

19. The method of claim 17 wherein the records comprise HEX records.
